(19) United States
(12) Patent Application Publication
(10) Pub. No.: US 2025/0065969 A1
(43) Pub. Date: Feb. 27, 2025

(54) OFF-ROAD CAPABLE TRAILER

(71) Applicant: FCA US LLC, Auburn Hills, MI (US)

(72) Inventors: Cole T. Schaenzer, Royal Oak, MI (US); Robert A. Rizzo, Macomb, MI (US); Meghan Deardorff, Clarkston, MI (US)

(21) Appl. No.: 18/453,349

(22) Filed: Aug. 22, 2023

(51) Int. Cl. B62D 63/06; B62D 33/03; B62D 63/08

(52) U.S. Cl. CPC B62D 63/062; B62D 33/03; B62D 63/08; B60G 9/02; B60G 2300/04

(57) ABSTRACT

A trailer includes a suspension assembly including two or more suspension components that are the same as corresponding suspension components that are manufactured for a Jeep® brand vehicle, and one or more body components that are the same as corresponding one or more body components that are manufactured for a Jeep® brand vehicle. The trailer may thus be made from several components used in making a vehicle, and may have similar capabilities and appearance as the vehicle with which it is used. In at least some implementations, components from the trailer can be used on the vehicle, and vice versa.

### FIELD

The present disclosure relates to a towable trailer and, more particularly, a towable vehicle trailer including vehicle components.

### BACKGROUND

Trailers can be hitched to and pulled by a vehicle, and provide extra cargo and storage space. The trailers are generally of simple design and are formed of components that specific to the trailer and very different from the vehicle with which they are used. Trailers typically include a simple axle design with two wheels on the axle, often have limited ground clearance and are designed for use on paved or other smooth roads.

### SUMMARY

In at least some implementations, a trailer includes a suspension assembly including two or more suspension components that are the same as corresponding suspension components that are manufactured for a Jeep® brand vehicle, and one or more body components that are the same as corresponding one or more body components that are manufactured for a Jeep® brand vehicle.

In at least some implementations, two tires are coupled to the trailer via the suspension assembly, and wherein the two tires are the same size as tires available on a brand-new Jeep® brand vehicle.

In at least some implementations, one or more body components includes a trailer cargo bed assembly. In at least some implementations, the trailer cargo bed assembly includes a tailgate that is the same as a tailgate for a Jeep® brand vehicle.

In at least some implementations, the two or more suspension components include upper and lower control arms. In at least some implementations, the two or more suspension components include two shock absorbers.

In at least some implementations, an axle is part of the suspension assembly and is the same as an axle that is manufactured for a Jeep® brand vehicle.

In at least some implementations, the one or more body components include two side body panels. In at least some implementations, the one or more body components include a tailgate that is pivotably coupled to a frame.

In at least some implementations, the one or more body components include a bumper at a rear end of the trailer.

In at least some implementations, a trailer includes a trailer body, having: a trailer frame; a trailer suspension coupled to the trailer frame; two wheels coupled to the trailer suspension; a trailer tongue coupled to the trailer frame; and a trailer cargo bed coupled to the trailer body by the trailer frame. At least two components of the trailer suspension are the same components as at least two components of a vehicle suspension of a vehicle with which the trailer is adapted to be used.

In at least some implementations, the trailer includes a tailgate in the form of a swinging-gate tailgate. In at least some implementations, the trailer includes a tailgate in the form of a drop-down tailgate.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle and a trailer releasably coupled to the vehicle;

FIG. 2 is a rear view of another vehicle;

FIG. 3 is a perspective view of the vehicle of FIG. 2;

FIG. 4 is a rear view of an illustrative embodiment of a trailer; and

FIG. 5 is a perspective view of the trailer of FIG. 4.

### DETAILED DESCRIPTION

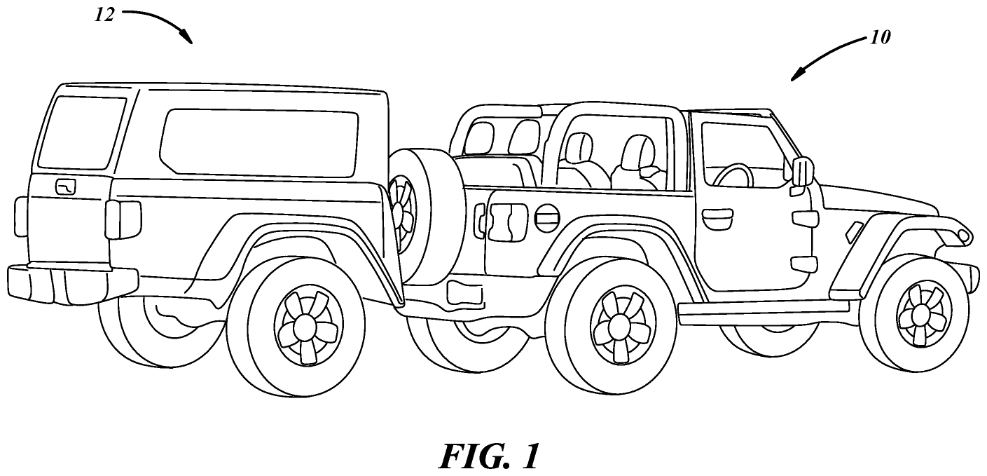

Referring in more detail to the drawings, FIG. 1 illustrates a vehicle 10 and a trailer 12 releasably coupled to the vehicle 10. In general, for ease of manufacturing and reducing cost, the trailer 12 may share some of the same or similar components of the vehicle 10. As will be discussed in more detail below, the trailer 12 may include two or more suspension components that are the same as suspension components used on the vehicle 10. While the present illustrative embodiment shows one type of vehicle, other vehicles may be desirable and the trailer 12 can share other components with the vehicle beyond the suspension components, such as similar body components (e.g., a storage or cargo bed, tailgate, body panels, wheels, bumper/rear fascia, etc.).

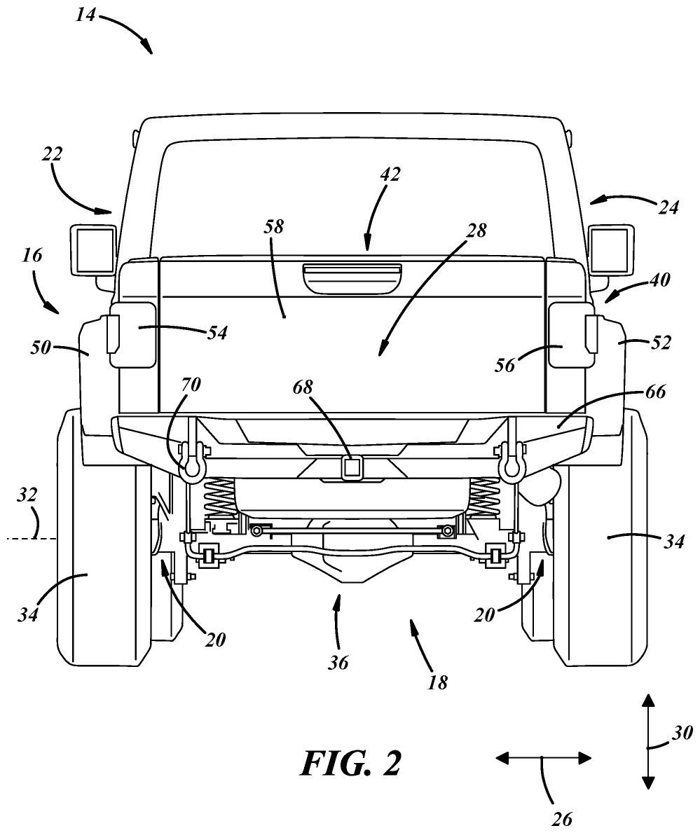

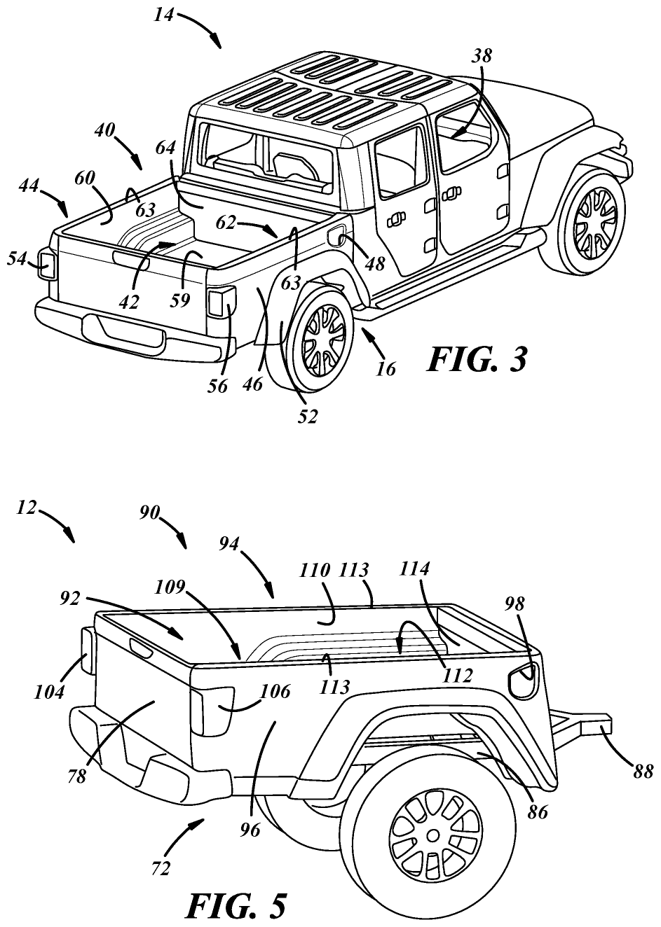

FIGS. 2 and 3 illustrate another vehicle with which a trailer may be used. The rear of the vehicle 14 is illustrated in FIG. 2 and it has a body 16 and multiple wheels coupled to the body 16 by a first suspension assembly, called a vehicle suspension assembly 18, having various suspension components. Two rear wheels 20 are spaced apart horizontally, sometimes called a cross-car direction, extending between driver and passenger sides 22, 24 of the vehicle 14, and shown by an arrow 26. The vehicle 14 extends into the page from the rear 28 of the vehicle 14 in a fore-aft direction, and the body 16 is suspended off a ground surface by wheels 20 and vehicle suspension 18 in a vertical direction shown by arrow 30, which is parallel to the direction of gravity when the vehicle 14 is on a flat, level road oriented perpendicular to gravity.

As the vehicle 14 moves, the wheels 20 rotate about a vehicle wheel axis 32. Tires 34 may be coupled to the vehicle 14 via the vehicle suspension 18. The vehicle suspension 18 can play a role in determining or setting a first ground clearance, called a vehicle ground clearance, which may refer to the amount of space between the ground or ground plane to the lowest point of an undercarriage of the vehicle 14 or first point of contact (e.g., where the vehicle would bottom out).

As shown in FIG. 2, the vehicle suspension 18 may include a so-called solid axle 36 with the wheels 20 coupled to opposite ends of the axle 36. The vehicle suspension 18 may allow the wheels 20 to move in several directions including vertically, for example, so that the position of the wheels 20 can accommodate changes in terrain on which the vehicle 18 is traveling. The vehicle suspension 18 may further include springs, shocks, control arms, stabilization bars, and other various known suspension components.

FIG. 3 illustrates the vehicle 14 generally including an interior 38 with front passenger seating and rear passenger seating. The vehicle 14 may include a storage or cargo bed assembly 40 (called herein a vehicle cargo bed) that provides a cargo area 42 fore-aft of the interior 38. The vehicle cargo bed 42 may include side body panels 44, 46 that are spaced cross-car from one another and coupled to the body 16 of the vehicle 14. One of the side panels 46 may include a hole 48 for access to a fuel fill pipe or a charging port, for example. One or more wheel flares 50, 52 (FIG. 2) may be coupled to the side body panels 44, 46 and extend outward in the cross-car direction from each of the side body panels 44, 46. Tail light assemblies 54, 56 which include a tail light and various electrical components may be arranged on each of the side body panels 44, 46 near the rear 28 of the vehicle 14, as shown in FIG. 2.

With reference to FIG. 2, the vehicle cargo bed 40 may include a tailgate 58 that is coupled to one or both of the side body panels 44, 46 and provide access to the cargo area 42. The tailgate 58 may be a drop-down tailgate that pivots about a lower end, as shown, a swinging-gate tailgate that pivots about the left or right side, as shown on the vehicle 10 in FIG. 1, or another tailgate that provides a user access to the cargo area 42 of the vehicle cargo bed 40.

The cargo area 42 may be defined by a floor 59, interior side walls 60, 62 that are inboard of the side body panels 44, 46, and a forward wall 64 extending cross-car between the interior side walls 60, 62 and separating the cargo area 42 from the vehicle interior 38, as shown in FIG. 3. A forward wall 64 may extend cross-car between the interior side walls 60, 62 and separate the cargo area 42 and the vehicle interior 38. Exterior trim pieces 63 may be arranged over a portion of the vehicle cargo bed 40 where the side panels 44, 46 respectively mate with interior side walls 60, 62 and extend along the length of the vehicle cargo bed 40.

At the rear 28 of the vehicle 14, a bumper 66 may be coupled to the body 16 and may extend cross-car at least partially between the side body panels 44, 46, as shown in FIG. 2. A hitch 68 coupled to the body 16 of the vehicle 14 and arranged in the center of the bumper 66 in the cross-car direction. Tow hooks 70 may be coupled to the body 16 of the vehicle 14 and arranged cross-car along the bumper 66.

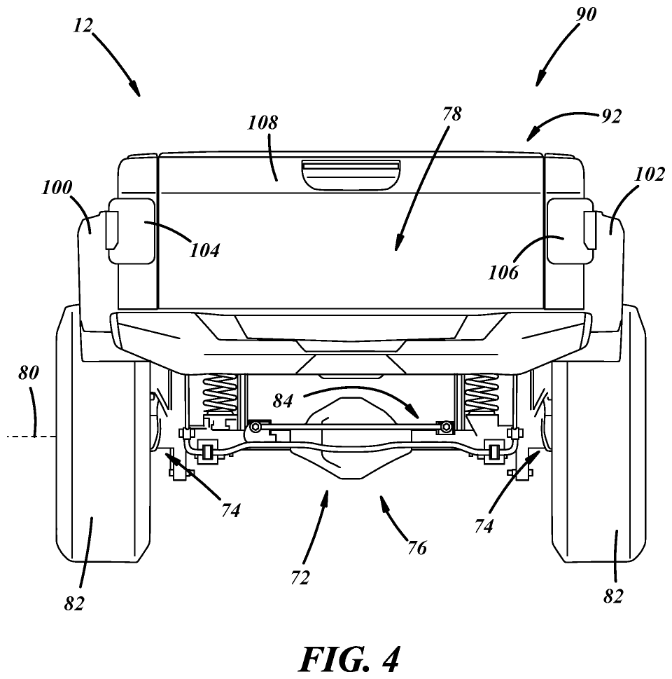

With reference to FIG. 4, the trailer 12 is illustrated including a body 72 and wheels 74 coupled to the body 72 by a second suspension assembly, called a trailer suspension assembly 76 (i.e., trailer suspension) having various suspension components. At least two components of the vehicle suspension assembly 18 may be the same components as at least two components of the trailer suspension assembly 76. For example, the trailer suspension assembly 76 may include the same shocks, springs, control arms (e.g., upper and/or lower) as the vehicle suspension assembly 18. The trailer wheels 74 are spaced apart horizontally in the cross-car direction, as shown in FIG. 4. The trailer 12 extends into the page from the rear 78 of the trailer 12 in the fore-aft direction, and the trailer 12 is suspended off a ground surface by wheels 74 and the trailer suspension 76 in the vertical direction. As the trailer 12 moves, the wheels 74 rotate about a trailer wheel axis 80.

Two tires 82 may be coupled to the trailer 12 via the trailer suspension 76. The tires 82 coupled to the trailer 12 may be the same size as the tires 34 coupled to the vehicle 14. The trailer suspension 76 can play a role in determining or setting a second ground clearance, called a trailer ground clearance, which may refer to the amount of space between the ground or ground plane to the lowest point of an undercarriage of the trailer 12 or first point of contact (e.g., where the trailer 12 would bottom out). The trailer ground clearance may be the same or greater than the vehicle ground clearance.

The trailer suspension 76 may include a so-called solid axle 84 with the wheels 74 coupled to opposite ends of the axle 84, as shown in FIG. 4. The axle 84 of the trailer suspension assembly 76 may be the same axle 36 of the vehicle suspension assembly 18. Similar to the vehicle 14, the trailer suspension 76 may allow the wheels 74 to move in several directions including vertically, for example, so that the position of the wheels 74 can accommodate changes in terrain on which the trailer 12 is traveling. The trailer suspension 76 may further include springs, shocks, control arms, stabilization bars, and other various known suspension components. As noted, some or all of these may be the same parts used on the vehicle.

With reference to FIG. 5, the trailer body 72 is shown and may include a trailer frame 86 and trailer tongue 88 extending fore-aft from the trailer frame 86. In the present illustrative embodiment, the trailer frame 86 and trailer tongue 88 are not components of the vehicle 14. The trailer frame 86 may be coupled to the trailer suspension 76 and support a trailer storage or cargo bed assembly 90 (called herein a trailer cargo bed 90). The trailer cargo bed 90 may share one or more following components with the vehicle cargo bed 40. In other words, one or more of vehicle cargo bed 40 components introduced with respect to the vehicle 14 may be the exact same as one of the following trailer cargo bed 90 components introduced with respect to the trailer 12. Sharing components amongst the vehicle 14 and trailer 12 may be desirable to reduce cost and simplify manufacturing of the trailer 12, and to provide a unified appearance of the vehicle 14 and trailer 12.

Similar to the vehicle cargo bed 40 side panels 44, 46, the trailer cargo bed 90 may include side body panels 94, 96 that are spaced cross-car from one another and coupled to the body 72 of the trailer 12, as shown in FIG. 4. The side panel 96 may include a hole 98 (FIG. 5) for a fuel system or a charging port in the event the trailer 12 is equipped with an onboard generator or a rechargeable battery, for example. One or more wheel flares 100, 102 may be coupled to the side body panels 94, 96 and extend outward in the cross-car direction from each of the side body panels 94, 96, as shown in FIG. 4. Tail light assemblies 104, 106 which include a tail light and various electrical components may be arranged on each of the side body panels 94, 96 near the rear 78 of the trailer 12.

With reference to FIG. 4, the trailer cargo bed 90 may include a rear tailgate 108 that is coupled to one or both of the side body panels 94, 96 and provide access to the cargo area 92. The rear tailgate 108, sometimes called the trailer tailgate, may be a drop-down tailgate that pivots about a lower end, as shown, a swinging-gate tailgate that pivots about the left or right side, as shown on the vehicle 10 in FIG. 1, or another tailgate that provides a user access to the cargo area 92 of the trailer cargo bed 90. As shown in FIGS. 2 and 4, the trailer tailgate 108 and the vehicle tailgate 58 are both drop-down tailgates, however, one tailgate may be a swinging-gate tailgate (FIG. 1) while the other tailgate is a drop-down tailgate.

The cargo area 92 may be defined by a floor 109, interior side walls 110, 112 that are inboard of the side body panels 94, 96, and a forward wall 114 extending cross-car between the interior side walls 110, 112, as shown in FIG. 3. Exterior trim pieces 113 may be arranged over a portion of the vehicle cargo bed 90 where the side panels 94, 96 respectively mate with interior side walls 110, 112 and extend along the length of the trailer cargo bed 90. In at least one embodiment, the forward wall 114 may be a front tailgate, such as a drop-down tailgate that opens in the fore-aft direction towards the vehicle 14, or another tailgate that extends toward the vehicle to occupy any space that exists between the trailer 12 and the vehicle 14 in the fore-aft direction. At the rear 78 of the trailer 12, a bumper 116 may be coupled to the trailer body 72 and may extend cross-car at least partially between the side body panels 94, 96.

The tongue 72 of the trailer 12 may be removably coupled to the hitch 68 of the vehicle 14 with via an articulating coupling device such as an articulating hitch. The articulating coupling device may allow the trailer 12 to move and rotate about 3 axes so that the trailer 12 is can easily travel across rough terrain while being towed by the vehicle 14, for example.

The sharing of components between the vehicle 14 and trailer 12 may permit the use of several accessories on the trailer 12 which were initially designed for the vehicle 14. For instance, a truck bed cap or bed liner configured for the vehicle 14 may be used with the trailer 12 without the need to modify the accessories. Ordinarily, trailers require all unique parts from the vehicle that tows the trailer, however, because trailer 12 is configured using two or more suspension component and may include one or more other vehicle components including body panels, taillights, bumpers, tailgates, etc., no such problem exists with trailer 12. Additionally, vehicles typical have abundant repair and replacement parts in the event they are needed, and such supply may be used for the trailer 12 too. Still further, when in a remote location, if the vehicle has, for example, a failure in a suspension component or wheel, then a trailer suspension component or wheel can be used to repair the vehicle and facilitate driving the vehicle out of the remote area, with or without the trailer. Still further, the trailer may have an appearance that is the same as or similar to a portion of a vehicle which may be desirable for some consumers.

In at least some implementations, the components shared between the trailer and vehicle are components that are made for a brand new vehicle, such as a Jeep® brand vehicle. The Jeep® vehicles may be sold by or on behalf of the original equipment manufacturer (OEM) of Jeep® vehicles and the components may components that are the same as those used by the OEM in a brand-new vehicle, or the components may be aftermarket components that are made for use on a Jeep® brand vehicle. The components may include body panels, cargo bed components, suspension components, tires and wheels, and the like. The similarity in appearance and performance of the components can make the trailer usable in terrain similar to that in which the vehicle is used, with similar off-road capability including similar suspension performance (e.g., the same axle assembly, control arms, springs and/or shocks) and similar or the same ground clearance (e.g., the ground clearance without cargo loaded in the vehicle or trailer). Further, use of the same components avoids the need to have specially made components for the trailer, and has other uses and advantages as noted herein.

What is claimed is:

1. A trailer, comprising:
a suspension assembly including two or more suspension components that are the same as corresponding suspension components that are manufactured for a Jeep® brand vehicle; and
one or more body components that are the same as corresponding one or more body components that are manufactured for a Jeep® brand vehicle.

2. The trailer of claim 1 wherein two tires are coupled to the trailer via the suspension assembly, and wherein the two tires are the same size as tires available on a brand-new Jeep® brand vehicle.

3. The trailer of claim 1 wherein the one or more body components includes a trailer cargo bed assembly.

4. The trailer of claim 3 wherein the trailer cargo bed assembly includes a tailgate that is the same as a tailgate for a Jeep® brand vehicle.

5. The trailer of claim 1 wherein the two or more suspension components include upper and lower control arms.

6. The trailer of claim 5 wherein the two or more suspension components include two shock absorbers.

7. The trailer of claim 1 which includes an axle that is part of the suspension assembly and which is the same as an axle that is manufactured for a Jeep® brand vehicle.

8. The trailer of claim 1 wherein the one or more body components include two side body panels.

9. The trailer of claim 1 wherein the one or more body components include a tailgate that is pivotably coupled to a frame.

10. The trailer of claim 1 wherein the one or more body components include a bumper at a rear end of the trailer.

11. A trailer, comprising:
a trailer body, including:
a trailer frame;
a trailer suspension coupled to the trailer frame,
two wheels coupled to the trailer suspension, and
a trailer tongue coupled to the trailer frame; and
a trailer cargo bed coupled to the trailer body by the trailer frame,
wherein at least two components of the trailer suspension are the same components as at least two components of a vehicle suspension of a vehicle with which the trailer is adapted to be used.

12. The trailer of claim 11 wherein the trailer includes a tailgate in the form of a swinging-gate tailgate.

13. The trailer of claim 11 wherein the trailer includes a tailgate in the form of a drop-down tailgate.

14. The trailer of claim 11 wherein the trailer includes a tailgate that is the same as a tailgate that is used on a Jeep® brand vehicle.

15. The trailer of claim 11 wherein the trailer suspension includes an axle that is the same as an axle manufactured for a Jeep® brand vehicle.

16. The trailer of claim 11 wherein the at least two components of the trailer suspension include upper and lower control arms.

17. The trailer of claim 11 wherein the at least two components of the trailer suspension include two shock absorbers.

18. The trailer of claim 11 which includes an axle that is part of the trailer suspension assembly and which is the same as an axle that is manufactured for a Jeep® brand vehicle.

19. The trailer of claim 11 wherein the trailer cargo bed includes two side body panels that are the same as body panels manufactured for a Jeep® brand vehicle.

20. The trailer of claim 11 wherein the trailer cargo bed includes a tailgate that is pivotably coupled to a frame and is the same as a tailgate manufactured for a Jeep® brand vehicle.
